(19) United States
(12) Patent Application Publication
(10) Pub. No.: US 2005/0289021 A1
(43) Pub. Date: Dec. 29, 2005

(54) Utility model billing system for propane and heating oil consumers

(76) Inventor: Peter John Lagergren, Glen Rose, TX (US)

Correspondence Address: Peter John Lagergren, 8505 Eastlake Drive, Burnaby, BC, V5A 417, CA

(21) Appl. No.: 11/131,441

(22) Filed: May 16, 2005

Related U.S. Application Data
(60) Provisional application No. 60/571,835, filed on May 17, 2004.

(51) Int. Cl. G06Q 50/00

(52) U.S. Cl. 705/28

(57) ABSTRACT

The invention describes a method whereby the measured consumption of propane and heating oil fuels can be used to provide a repetitive “utility style” billing method for consumers. The method involves the use of measurement methods that provide a close estimate of actual liquid volume in a fuel container and reconciles that measurement with the amount delivered to the consumer with each inventory replenishment cycle that uses an approved custody transfer meter.

### REFERENCES CITED

This application is based on and includes the information in provisional application 60/571835 filed on May 17 2004.

### BACKGROUND OF THE INVENTION

The present invention relates to a system for ultrasonically sensing the level of fuel in a liquid fuel tank and billing the consumer of the fuel on a usage basis. It is considered particularly suitable for but not limited to the use of propane liquid and heating oil in a fuel tank.

In North America and throughout the world, there are substantial numbers of propane and heating fuel tanks installed outside residential and commercial premises to provide energy for heating, cooling and cooking. These tanks can range in size from ones which have a relatively small capacity (e.g. 50 gallons) to ones which have a relatively large capacity (e.g. 1000 gallons or more). Often, the fuel is sold by a distributor to its customers under a contract where the distributor provides the customer with the tank in return for the exclusive right to supply the customer with the fuel.

Typically, propane tanks and fuel oil tanks are filled by the distributor on the basis of estimated usage which is calculated using “degree lapse days” which attempts to estimate usage with climatic data, historical data, and time of years predictions. This method has certain advantages including (1) that there is no infrastructure required to produce the data other than the distributor's existing accounting infrastructure and (2) that any sufficiently large distributor will have a significant amount of historical data from which to draw. But, there are also disadvantages. There can be sufficient granularity in the data that a conservative approach to inventory management requires an average fill per tank of 45% to 50% of total volume instead of a more desirable 80% of total volume, the latter of which obviously allows the distributor to make less frequent trips to the customer with a fuel delivery truck. Further, if a distributor's estimates of a estimated usage are sufficiently in error, there can be a significant number of “out of gas” events which may lead to the loss of a customer. Moreover, without knowing the actual inventory kept in its customer's tanks, a distributor cannot use that data to optimize long term/short term purchasing contracts for propane.

Accordingly, there is a need in the fuel delivery industry for a direct method of monitoring customer inventory. In this respect, there are existing fuel tank mounted mechanical gauges which can be installed to provide an approximate indication of inventory. However, the readings they provide are typically quite unreliable (e.g. an error range of plus or minus 10% to 20%). An option that would provide improved accuracy would be to install on each tank a totalizing flow meter like that used by a fuel truck when delivering fuel to a tank, or comparable to that used by utilities that supply electricity, natural gas or water to utility customers. Then, the total volume of fuel removed from the tank then could be recorded and regularly compared with the volume when the tank was filled. However, apart from the cost of installing and maintaining such precision flow meters, the customers of a propane distributor are often located in non-urban areas. The distance between such customers can be too large to justify the repetitive manual collection of usage data.

### BRIEF SUMMARY OF THE INVENTION

In accordance with the present invention, there is provided a new and improved method to periodically bill for the usage of product as it is drawn from the fuel storage tank.

The system includes an ultrasonic transducer unit externally mountable on the bottom of the tank and a control unit operably connectable to the transducer unit. In a preferred embodiment where the tank is a propane tank or a heating oil tank, the control unit is preferably mounted atop the tank and is connected to the transducer unit by an electrical cable.

The transducer unit includes a piezoelectric crystal (“piezo”) transducer, a piezo driver circuit, and preferably a temperature sensor. In cases where the fuel tank is a steel wall propane tank, it has been found that the transducer unit advantageously further includes an aluminum disk normally interposed between the piezo and the tank wall to provide improved acoustic coupling.

In response to command signals from the control unit, the piezo driver circuit causes the piezo to transmit ultrasonic pulse trains having a controlled pulse frequency through the wall of the tank (and the aluminum disk if included), and to listen for return echoes from the surface of liquid in the tank. Echo return signal information is sent back to the control unit from the transducer unit.

The process of transmitting ultrasonic pulse trains into a fuel tank and listening for return echoes is referred to herein as “pinging” the tank. As is well understood by those skilled in the art, the time that it takes for a transmitted signal to the reach the liquid surface and to be echoed back (viz. time-of-flight) will correspond to the liquid level. With knowledge of the tank geometry, a measurement of the volume of fuel in the tank then can be calculated.

The temperature sensor mentioned above is desirable because, as is also well understood by those skilled in the art, tank geometry will vary with increasing or decreasing temperatures. Thus, the time-of-flight measured at one temperature may be the same as the time-of-flight measured at another temperature. Yet, the actual volume of fuel in the tank at the two temperatures may differ. With knowledge of the temperature and tank geometry as a function of temperature, a more accurate measurement of the volume of fuel in the tank can be calculated at any given temperature. When the transducer unit includes a temperature sensor, a signal corresponding to temperature is sent back to the control unit from the transducer unit.

In the present invention there is provided a method enabling a fuel distributor to reliably maintain an acceptable volume of fuel in a customer's fuel tank (e.g. a propane tank or heating oil tank) during the time period from one fuel delivery to the next (viz. a delivery cycle) while estimating the amount of fuel used during predetermined time intervals within the time period. For example, the time intervals within a given time period or delivery cycle may be monthly intervals corresponding with a monthly billing cycle. Advantageously, this method may be implemented in conjunction with an ultrasonic fuel level monitoring system as described above.

The foregoing and other features and advantages of the present invention will now be described in more detail with reference to the drawings.

### BRIEF DESCRIPTION OF THE DRAWINGS

FIG. 1 is a perspective view illustrating mechanical aspects of an ultrasonic fuel level 15 monitoring system in accordance with the present invention when mounted to a propane fuel tank.

FIG. 2 is a high level block diagram of the monitoring system shown in FIG. 1.

FIG. 3 shows a working environment for the propane tank and the monitoring system shown in FIG. 1.

FIG. 10 illustrating the processing of data utilizing a system like that shown in FIG. 2 for the purpose of monitoring fuel usage, determining when a fuel tank requires refill and facilitating customer billings based upon usage.

### DETAILED DESCRIPTION OF THE INVENTION

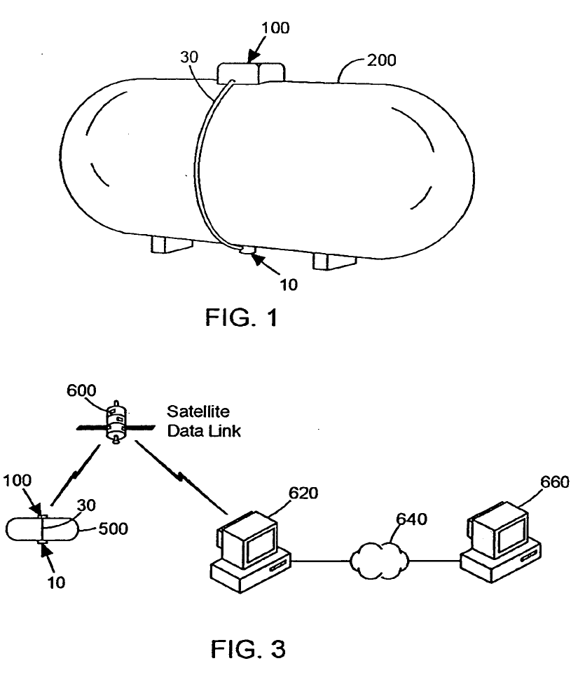

Referring to FIG. 1, there is shown an ultrasonic fuel level monitoring system for sensing the level of liquid in a propane fuel tank 500. The system includes an ultrasonic transducer unit generally designated 10 externally mounted on the bottom of the tank and a control unit generally designated 100 externally mounted on the top of the tank. Control unit 100 is operably connected to transducer unit 10 by electrical cable 30. As described below in more detail, the transducer unit transmits ultrasonic signals through the wall of tank 500 and listens for return echoes from the surface of propane liquid (not depicted) contained in the tank. The control unit directs the operation of the transducer unit and collects time-of-flight data and temperature data from the transducer unit.

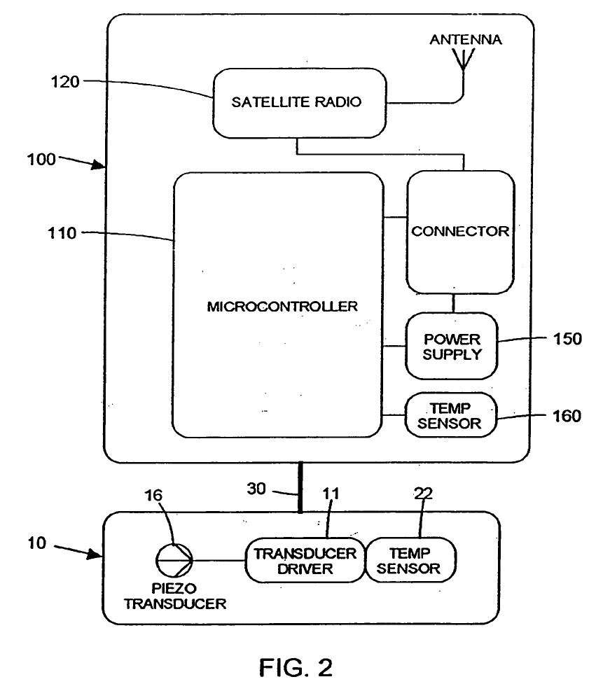

As shown in FIG. 2, transducer unit 10 comprises a transducer driver 11, a piezoelectric crystal transducer or piezo 16, and a temperature sensor 22. Temperature sensor 22 is used to obtain a measurement of the temperature of tank 500 which is desirable in order to adjust readings taken for accuracy (e.g. within plus or minus 2%). Control unit 100 comprises a very low power microcontroller 110 connected to a satellite radio 120, a battery power supply 150 and an ambient temperature sensor 160. To minimize size and cost, radio 120 is preferably a simplex radio capable of transmitting but not receiving.

FIG. 3 illustrates a working environment wherein data collected by control unit 100 from transducer unit 10, including time-of-flight data and temperature data, is transmitted by radio from control unit 100 via a satellite data link 600 to a computer 620. Computer 620 includes a computer readable storage medium which receives the data input and, together with previously stored information on tank geometry and dimensions and a suitable computer program product, processes the received data to calculate a measure of the volume of fuel in tank 500. The calculated measure is also stored in the storage medium and may be read-out and displayed by computer 620. Via a further data link (e.g. the internet 640), the calculated measure may also be read-out and displayed from computer 620 by a second computer 660.

It will be appreciated that the foregoing working environment is one which can be expanded to a system where a centralized server computer (e.g. computer 620) receives data transmissions via satellite from numerous control units 100 each monitoring a different propane tank (e.g. tank 500). The propane tanks may be located at widely dispersed geographic locations. Some may be serviced by the same propane distributor and others may be serviced by different propane distributors. Each distributor could utilize its own computer 660 to receive data from computer 620 concerning the customers it services.

The fuel level monitoring system described above not only facilitates regular monitoring of the amount of fuel in a fuel tank, but also facilitates the ultimate billing of customers and fuel inventory management. In this regard, it is useful to first note traditional methods used in the propane and heating fuels distribution industry whereby distributors receive payments from customers.

One method used is the “will call” method where the customer is responsible for maintaining it own inventory of fuel and replenishes its fuel tank storage by calling the distributor and requesting delivery. The product is delivered by a tank truck which has a precision flow meter and totalizer attached to the delivery pump. During a delivery, the totalizer records the volume of product supplied to the tank and applies temperature corrections to the fluid being delivered. The totalizer is typically inspected by governmental Weights and Measures authorities or agents on a calendar date basis to ensure accurate delivery and billing. At the completion of the delivery, the customer is presented with a bill for the entire amount of the delivery based upon the amount of delivered product shown by the totalizer.

A second method used is the “guaranteed inventory” method where the distributor takes responsibility for maintaining the customer's inventory and ensuring that the customer never runs out of product. The distributor uses a computerized prediction formula based on the average daily temperature and the historical usage of the customer to attempt to predict the most advantageous time to refresh the inventory. After the distributor has made a delivery, an invoice based on the totalizer reader taken at the time of delivery is mailed to the customer.

A third method used is the “average billing” method. In this case, the customer is either a “will call” or a guaranteed inventory” customer, but the payment for each of the deliveries to the customer is spread out over a period of time to lessen the economic impact of delivery.

All three of the above methods are less desirable than a utility model where the customer is billed on a pay-as-you-go basis.

For example, in the case of a “will call” customer, the bill for a typical delivery may be in the range of $200.00 to $800.00. This is significant. It is also a marketing problem for the distributor in that it motivates the customer to ask for replenishment on a much more frequent basis to reduce the out-of-pocket cost of each delivery. This has an obvious downside for the distributor in that it minimizes the size of delivery and maximizes the per-unit costs of making the delivery.

In the case of the “guaranteed inventory” method, and in the absence of any on-site tank monitoring equipment, the distributor is often obliged to make mote trips than theoretically necessary to ensure that the customer never runs out of fuel. The billing issues are the same as with the “will call” method. The customer may be presented with a substantial bill. Since the distributor makes delivery on its own schedule, the customer is unaware when delivery will be made and an invoice sent.

With the “average billing” method, the fuel distribution industry attempts to emulate the utility model with regular, predictable billing cycles. This method has not been particularly popular with customers because they do not like to continue receiving bills during low use periods such as summers. While the economics of this method are sound, it has been difficult to move customers to this method.

A fourth method which is generally not used in the fuel distribution industry would be to have a Weights and Measures approved totalizing flow meter installed at a customers premises in the same way as electricity, water and natural gas are often delivered and billed. This method has not been used because the users of propane and heating oil are often in non-urban areas and the distance between customers is too large to justify the repetitive manual collection of usage data.

It is noteworthy that existing fuel tank mounted mechanical gauges for fuels are only accurate at the plus or minus 10% to 20% levels and cannot be made capable to receive Weights and Measures approval. They are installed only as approximate indicators of inventory. Industry representatives have indicated that a significant number of these mechanical gauges are inoperative and are not economically repairable.

The method monitoring fuel usage and determining amount to be billed which is facilitated by the present invention comprises the steps of:
STEP 1: Filling the tank to a predetermined fuel level with a first accurately measured volume of fuel and storing in a computer readable storage medium (e.g. part of computer 620) a first value, the first value corresponding to the measured volume.

Accurate measurement may be made with precision flow meter and totalizer as noted above.

In the case of propane tanks, it may be noted that the maximum fill capacity of a tank is necessarily determined at the time of manufacture. However, since there is no reliable way to accurately know the actual liquid volume in a tank during a fill cycle, safety regulations typically demand that the tank be filled no further than some fixed level, typically 0% of capacity. This is the predetermined level noted above. While the tank is being filled, the deliverer opens a petcock on the top of the tank that has a dip tube attached to it. The tube protrudes into the interior of the tank and is open to the tank vapor at the 80% level. The petcock will outgas a small quantity of propane vapor as long as the end of the dip tube is in the vapor space of the tank. When liquid propane rises to the bottom of the dip tube, the outgassing vapor is replaced by a small liquid stream. This is the point at which the deliverer normally will stop pumping propane into the tank. Typically, there is also an overflow protection valve that opens at the 90% full point and opens the tank to atmosphere until a sufficient quantity of propane has escaped to reduce the liquid level.
STEP 2: With a monitoring system attached to the tank, frequently sensing during each time interval at least approximately the volume of fuel in the tank, and transmitting over a communication link signals corresponding to the volume of fuel so sensed.

Preferably, the volume of fuel in a propane tank is sensed with a monitoring system as described above, and the communication link includes a satellite radio and data link as described above. As discussed below, compliance with regulations requiring precision measurements may be maintained without the necessity for volumes to be sensed with the same precision as in STEP 1.
STEP 3: Receiving the transmitted signals and, in response to each signal received, storing in the computer readable storage medium a second value, each second value corresponding to the sensed volume of fuel remaining in the tank.

In the preferred embodiment, the communication link also includes a satellite radio receiver (not shown in FIG. 2) which receives the signals sent via satellite from the monitoring system. The computer readable storage medium is operatively coupled to the receiver. The receiver may be a centralized satellite receiving station remote from the fuel tank, and the computer readable storage medium may be at a location remote from both the fuel tank and the satellite receiving station. Communications between the satellite receiving station and the computer readable storage medium may be implemented by various means known means. This enables a fuel distributor to efficiently service a number of customers at a number of sites and to utilize a centralized satellite receiving station to receive information transmitted from the customer sites.
STEP 4: With a computer program product stored in the computer readable storage medium, comparing each second value (from STEP 3) with a predetermined minimum threshold value also stored in the medium.

The minimum threshold value is one which indicates that the fuel level in the tank is running low. While in any given case the actual threshold value may depend upon a customer's particular circumstances, it is considered that a threshold which corresponds to about 20% of tank capacity normally will be suitable.
STEP 5: If the second value is not less than the minimum threshold value, and if a predetermined time interval (e.g. a billing cycle) has lapsed, then calculating with the computer program product the difference between the first value (from STEP 1) and the second value (from STEP 3).

This difference will correspond to estimated fuel usage during the time interval. It is an amount which can be read out by computer, or which can be further processed by computer and peripherals to calculate an amount to be billed and to generate a customer billing.
STEP 6: If the second value is not less than the minimum threshold value, and if the predetermined time interval has not lapsed, then return to STEP 2.
STEP 7: If the second value is less than the minimum threshold value, then:
(i) generating with the computer program product a signal warning that the volume of fuel in the tank is low;
(ii) in response to the refill signal, filling the tank to the above-mentioned predetermined fuel level with a second accurately measured volume of fuel and storing in the computer readable storage medium a third value, the third value corresponding to the second measured volume of fuel;
(iii) with the computer program product, calculating a reconciliation amount corresponding to the difference between the third value and the second value.

Ideally, the reconciliation amount between the third value and the second value will be zero. In practice, and by reason of inherent measurement inaccuracies, it may to be a slightly positive or a slightly negative amount. In any case, it is an amount which can be read out by computer, or which can be further processed by computer and peripherals to calculate an amount to be billed or to be credited to the customer.

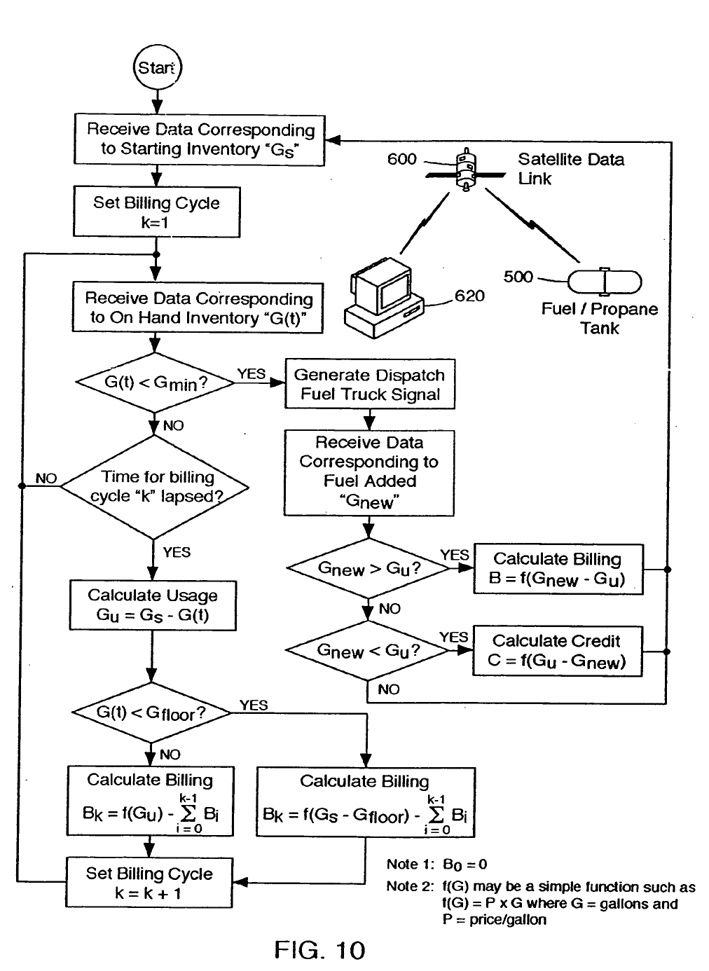

A preferred implementation of the foregoing method is schematically shown in FIG. 10.

In practice, and as a preliminary step a distributor and customer typically would execute a contract allowing the distributor to bill from the “estimated” usage reported by the monitoring system. The billing cycle would be constrained by the volume of the fuel tank, but the customer would be guaranteed to never pay more than the maximum possible usage available from the tank. A “comfort level” below which the distributor would never bill may be provided. As a subsequent step at the completion of each delivery cycle, the distributor's accounting system will “true up” the previous bills to reflect the difference between a known delivery volume and the previously billed volume. Typically, the differences between the estimated usage and the actual usage should be very small.

Since the product billing cycle normally will be based on a Weights and Measures approved totalizer, the customer is assured that the distributor can never bill more than the amount shown on each delivery inventory cycle.

For the distributor, the foregoing system is advantageous because it emulates a billing process like that in areas where direct-connect utilities are available. A secondary advantage is that the distributor is allowed to retain title to the fuel in the fuel tank until it is actually used by the customer. This allows the distributor to inventory fuel bought at low-usage and low-cost periods in the tank of its customers, and to sell the fuel to the customer during high-usage, high-cost periods. The net effect is that the distributor greatly increases its storage capacity for fuel without having to purchase and install large holding tanks on its premises. As well, the distributor has more flexibility in managing its wholesale purchasing cycle.

The customer has an advantage in that billing is based on a pay-as-you-go method, and the customer has the ability to modulate its usage, and its payments, as it pleases.

### EXAMPLE 1

The fuel level monitoring system is installed on a 500 gallon propane tank with an indeterminate quantity of fuel in the tank. The monitoring system then reports the tank as having 350 gallons of product. This is used as the baseline inventory value and is also used to determine the upper limit of billing.

During the next several months, the customer draws down the inventory. Each month, the distributor invoices the customer for the measured usage. At the end of three months, the monitoring system signals that the customer tank requires replenishment.

At replenishment, the delivery driver fills the tank to the maximum available volume i.e. 400 gallons and notes 350 gallons delivered as evidenced by a custody transfer meter on the delivery truck.

Once the delivered volume is entered into the distributor's billing system, a reconciliation 5 calculation is performed. The format of the calculation may be as follows:

| | | |
|---|---|---|
| Starting Inventory as reported by | 1350 gallons | |
| the monitoring system: | | |
| First months billing: | 175 gallons | ,On Hand 275 Gallons |
| Second months billing: | 180 gallons | ,On Hand 195 Gallons |
| Third months billing: | 1130 gallons | ,On Hand 65 Gallons |
| Custody transfer amount: | 1350 gallons | ,On Hand 400 Gallons |
| Billed amount: | 1285 gallons | |
| Difference between billed amount | ,Unknown | |
| and delivered amount: | | |

The foregoing scenario assumes that the volume in the tank as originally measured by the monitoring system is unknown. However, during the second delivery cycle, the actual inventory is known because the tank is filled to the level where fluid begins to escape from the vapor relief valve of the fuel tank.

| | | |
|---|---|---|
| Starting Inventory: | 1400 gallons | |
| Fourth months billing: | 175 gallons | ,On Hand 325 Gallons |
| Fifth months billing: | 1100 gallons | ,On Hand 225 Gallons |
| Sixth months billing: | 1130 gallons | ,On Hand 95 Gallons |
| Custody transfer amount: | 1325 gallons | ,On Hand 400 Gallons |
| Billed amount: | 1305 gallons | |
| Difference between billed amount | ,−20 gallons | |
| and delivered amount: | | |

At this point, the distributor would invoice the customer for the unrecognized 20 gallons not reported by the monitoring system. In this case the usage was underestimated by the system.

The preceding illustrates a worst possible case in that the billing cycle began with an indeterminate amount of fuel. In a best possible case, the billing regime would only begin at a replenishment fill. Then, the inventory on hand would an accurately known quantity.

### EXAMPLE 2

The usage reported by the monitoring system is greater than the actual usage. In this case, the distributor uses a “floor” value (e.g. 20%) as the billing limit during a usage/replenishment cycle.

| | | |
|---|---|---|
| Starting Inventory as reported | 1400 gallons | |
| by the monitoring system: | | |
| First months billing: | 180 gallons | ,On Hand 320 Gallons |
| Second months billing: | 1110 gallons | ,On Hand 210 Gallons |
| Third months billing: | | |
| Estimate usage: | 140 gallons | ,On Hand 70 Gallons |
| Less “floor” inventory: | 10 gallons | |
| Net invoice: | 1130 gallons | |
| Custody transfer amount: | 1330 gallons | ,On Hand 400 Gallons |
| Billed amount: | 1320 gallons | |
| Difference between billed amount | ,−10 gallons | |
| and delivered amount: | | |

At this point, the distributor would invoice the customer for the unrecognized 10 gallons over reported by the monitoring system, but limited by the “floor” amount.

### EXAMPLE 3

In this example, the monitoring system overestimates usage but does not hit the “floor” limit.

| | | |
|---|---|---|
| Starting Inventory as reported | 1400 gallons | |
| by the monitoring system: | | |
| First months billing: | 180 gallons | ,On Hand 320 Gallons |
| Second months billing: | 1120 gallons | ,On Hand 210 Gallons |
| Third months billing: | 1120 gallons | ,On Hand 80 Gallons |
| Custody transfer amount: | 1300 gallons | ,On Hand 400 Gallons |
| Billed amount: | 1320 gallons | |
| Difference between billed amount | ,+20 gallons | |
| and delivered amount: | | |

At this point, the distributor would credit the customer for the over-billed 20 gallons reported by the monitoring system.

1. What is claimed in this invention is a method of billing for the usage of propane and heating oil and; a method of reconciling consumer usage of propane and heating oil measured with a non-custody transfer metering/inventory monitoring method and an aproved custody transfer meter.
